(19) United States
(12) Patent Application Publication
(10) Pub. No.: US 2023/0091139 A1
(43) Pub. Date: Mar. 23, 2023

(54) APPARATUS, METHOD, SYSTEM FOR THE DETERMINATION OF BLOODBORNE FACTORS INDICATIVE OF INFLAMMATION

(71) Applicant: Alcor Scientific, Inc., Smithfield, RI (US)

(72) Inventors: Peter Sacchetti, North Falmouth, MA (US); Francesco Frappa, Udine (IT)

(21) Appl. No.: 17/933,986

(22) Filed: Sep. 21, 2022

Related U.S. Application Data
(60) Provisional application No. 63/246,923, filed on Sep. 22, 2021.

(51) Int. Cl. G01N 15/05

(52) U.S. Cl. CPC G01N 15/05; G01N 2015/045

(57) ABSTRACT

An apparatus includes a collection tube for containing a sample, a reading cell container including windows, the collection tube linked to the reading cell container to provide the sample to the reading cell container, a collimated light source composed in such way that light passes through the windows of the reading cell container and is reflected therein, an optical detector for the evaluation of collimated light attenuated by the sample within the reading cell container; and an electronic control device linked to the collection tube, collimated light source and optical detector.

### CROSS REFERENCE TO RELATED APPLICATIONS

This application claims benefit from U.S. Provisional Patent Application Ser. No. 63/246,923, filed Sep. 22, 2021, which is incorporated by reference in its entirety.

### BACKGROUND OF THE INVENTION

The present invention relates generally to the determination of a test value corresponding to various bloodborne factors, and more particularly to an apparatus, method, system for the determination of the bloodborne factors which are indicative of the presence of inflammation

In general, the state of the art for the determination of a test value corresponding to various bloodborne factors is the acquisition of an aggregogram or syllectogram of a blood sample. This is ascertained by reference to the article “Syllectometry, a new method for studying rouleaux formation of red blood cells” by Zijlstra published in 1963. The Syllectogram, the light variation over time plot, has application in the field of interest since it previously has correlated with the commonly applied erythrocyte sedimentation rate (ESR) test. Other factors are extractable from the analysis of particular features of the typical syllectogram.

Analysis of syllectogram data obtained with the disclosed methods, compared with data obtained by standard laboratory technique, has demonstrated the ability to quantitatively determine acute phase proteins presence effect in a quick and simple manner.

Syllectometry is a measuring method that is commonly used to determine the red blood cell aggregability, which can be related to fibrinogen concentration. As reference, in syllectometry light is incident to a layer where the sample is exposed to shear stress. Luminous flux attenuation/increase or backscatter ultrasound wave are used for determination of variations in sample properties after the abrupt stop of driving mechanism. The subsequent time-dependent plot is called syllectogram.

Alternatively, the syllectogram may be obtained by the introduction of a mechanical aggregates disruption such as that provided by ultrasonic energy.

### SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

In general, in one aspect, the invention features an apparatus including a collection tube for containing a sample, a reading cell container including windows, the collection tube linked to the reading cell container to provide the sample to the reading cell container, a collimated light source composed in such way that light passes through the windows of the reading cell container and is reflected therein, an optical detector for the evaluation of collimated light attenuated by the sample within the reading cell container; and an electronic control device linked to the collection tube, collimated light source and optical detector.

In another aspect, the invention features an apparatus including an optical receiver positioned to detect light from a blood sample portion including red blood cells that have aggregated, a main controller coupled to the optical receiver for recording an aggregation rate of the red blood cells of the blood sample portion upon detected light variation, a hydraulic circuit for providing the blood sample portion, and a light emitter source to pass light into the blood sample portion.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

These and other features, aspects, and advantages of the present invention will become better understood with reference to the following description, appended claims, and accompanying drawings where:

FIG. 1 is a block diagram.

### DETAILED DESCRIPTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

The present invention is directed towards an apparatus, a method, and a system for the determination of the aggregation rate of red blood cells. More specifically, the present invention is a method, a system, and the relative apparatus used to determine the aggregation rate of red blood cells, and other parameters related to these, such as acute phase proteins in the field of in vitro medical analyses, using optical systems after or during inducted forces for red blood cell disruption and redistribution generated by premixing, laminar and turbulent flow or in situ ultrasound waves.

The present invention provides a method and a relative reusable apparatus for the determination of aggregation rate index, and subsequent acute phase proteins concentration for whole blood samples. The present invention can also be used to derive other rheological parameters such as red blood cell deformability, red blood cell elasticity and whole blood density.

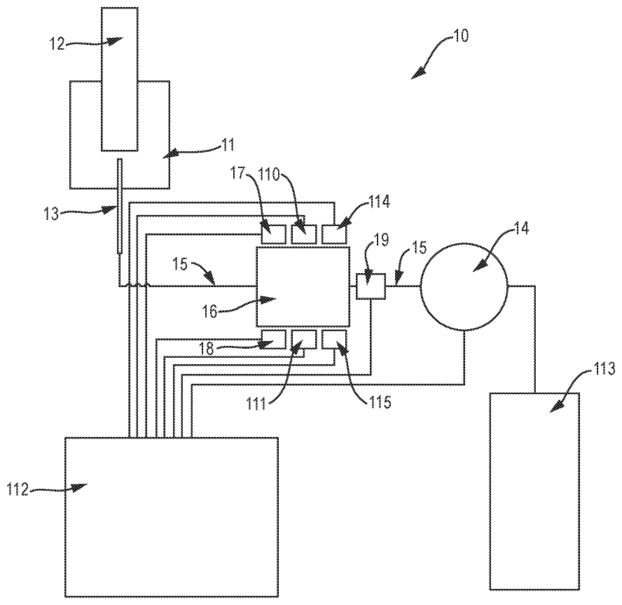

As shown in FIG. 1, an exemplary apparatus 10 for a determination of red blood cell (RBC) aggregation, and their subsequent sedimentation rate, includes a reading cell container 16 where a sample is introduced. The apparatus 10 provides this reading cell container 16 equipped with two parallel optical windows for allowing light radiation to pass through the sample therein introduced or reading the backscatter of the incident light. The apparatus 10 includes a collimated light source 17 composed in such way that light passes through the windows of the container 16 mentioned above, and can be reflected. On the opposite side of the light source 17, there is an optical detector 18 for the evaluation of the light attenuated by the sample. The optical detector 18 can be positioned on the same side of the light source 17 for the detection of light scattering. The reading cell container 16 is equipped with electromechanical actuators 110, 111 able to vibrate the sample herein introduced, disrupting the RBC aggregates that naturally form in the blood sample when in stasis, and evenly distributing the erythrocytes within the entire volume of sample. The apparatus 10 has a temperature control system 114, 115 for the sample container 16 to standardize the reaction environment.

The apparatus 10 includes an electronic control device 112 able to acquire the optical variance detected by the optical detector 18, drive the electromechanical actuators 110,111 and acquire the container temperature values. This electronic control device 112 is also able to convert a detected time dependent light variation into an aggregation index and a subsequent erythrocyte sedimentation rate, providing a result of the evaluated phenomenon in the way of a numerical result comparable to the commonly used parameters used in a clinical laboratory.

In an embodiment, the apparatus 10 includes of a mixer device 11 for a low homogenization of the sample inside a collection tube 12. The homogenization can be achieved by a Vortex-like mixer or by the radial or axial rotation of the sample tube, or a combination of the two techniques. Vortex mixers are one of the primary technologies for mixing laboratory samples in test tubes, well plates, or flasks. Vortex mixers use a fairly simple mechanism to agitate samples and encourage reactions or homogenization with high degrees of precision. Motorized drive shafts beneath a sample platform oscillate rapidly and transfer orbital motion to sample containers loaded into the vortex mixer. This causes sample fluids to circulate and undergo turbulent flow, otherwise known as a vortex.

After homogenization, the sample is then withdrawn by a needle 13 and aspirated by a pump device 14 through a hydraulic circuit 15. The hydraulic circuit 15 connects the aspiration needle 13 to the reading cell container 16 to enable their filling by the sample, guaranteed by the optical sensor composed by the emitter 17 and an optical receiver 18 and a secondary optical flow sensor 19 controlled by an electronic control device 112.

The light emitter source 17 includes, in one embodiment, a light emitting diode (LED), and can be substituted, for example, by a laser source or an incandescent lamp. The optical receiver 18, in this embodiment, may include a charge-coupled device (CCD) sensor for two dimensional characterization of the reaction or linear photodiode array for a monodimensional characterization. This CCD sensor can be substituted with a single receiver element such as photodiode, photomultiplier, and so forth.

After a complete or desired filling of the reading cell 16, the pump device 14 is stopped by the electronic control device 112, and the sample is processed by the electromechanical devices 110, 111, for example composed by piezoceramics, activated to a predetermined power by the control device 112, to disrupt aggregates and evenly re-suspend the RBC on the sample volume. One prerequisite for an aggregation kinetic detection is a complete disruption of the RBC aggregates, normally formed when the sample is in stasis. This emulsification can be achieved by an intensive mixing phase before and during the transportation of the sample in the reading cell or detection.

As an alternative embodiment to a predetermined power, the piezoceramic power is initially ramped up to a level where red blood cell disruption is detected through the optical reading. This process is stopped and a duplicate sample is introduced. The power applied can be optimized at a fraction of the red blood cell disruption power level which results in maximum dispersion, without cell damage.

During this phase, the control device 112 acquires the signal detected by the optical receiver 18 and stops the electromechanical devices 110, 111 or actuators when the light variation detected by the receiver 18 stops decreasing, indicating the complete disruption of the aggregate present into the sample. This recorded plot expresses the disruption rate of the RBC aggregates and is post-evaluated by the apparatus 10.

In one embodiment, the shape of the reading cell container 16 walls includes sound lenses for focusing a wave pressure shear to emphasize a shear inducted to the sample.

After the electromechanical devices 110,111 stop, the signal detected by the receiver 18 is still recorded by the control device 112 for a predetermined amount of time as a plot of kinetic aggregation.

After the end of the acquisition, the sample is evacuated from the reading cell 16 by the pump device 14 to a waste reservoir 113. During the evacuation, the electromechanical devices 110, 111 are activated with a high power to remove proteins bonded to the walls of the reading cell container 16. An evacuation of the reading chamber 16 avoids the pollution of the sample currently under measure by a residual of the previous measured sample with washing and does not require a large flow amount of sample currently under measure for removal the residuals of the previous measured sample. After the evacuation, the apparatus 10 is ready for a new sample and analysis.

The reading cell container 16 is also maintained to a controlled temperature by the thermoelectric device 114 and the temperature is acquired by the control device 112 through the temperature sensor 115 for providing standardized conditions of reaction.

During the dispersion phase induced by the electromechanical devices 110, 11, the resultant signal is evaluated to extract a mean viscosity value of the sample plasma by considering the time needed by the sample to completely re-suspend. After a complete re-suspension of the sample, a burst of ultrasound waves is induced to the sample for evaluating the red blood cell deformability. This deformability is considered as a time needed by the media to absorb a wave shear impressed, also decay after the wave share absorption is evaluated in function of time as index of the mean shape recovery ability.

It should be appreciated that the system, method, and apparatus may include one or more components or steps listed above in a variety of configurations depending upon desired performance or requirements.

It would be appreciated by those skilled in the art that various changes and modifications can be made to the illustrated embodiments without departing from the spirit of the present invention. All such modifications and changes are intended to be within the scope of the present invention except as limited by the scope of the appended claims.

What is claimed is:

1. An apparatus comprising:
a collection tube for containing a sample;
a reading cell container including windows, the collection tube linked to the reading cell container to provide the sample to the reading cell container;
a collimated light source composed in such way that light passes through the windows of the reading cell container and is reflected therein;
optical detector for the evaluation of collimated light attenuated by the sample within the reading cell container; and
an electronic control device linked to the collection tube, collimated light source and optical detector.

2. The apparatus of claim 1 further comprising a mixer device for a low homogenization of the sample inside a collection tube.

3. The apparatus of claim 2 further comprising:
an aspiration needle positioned within the link between the collection tube and the reading cell container;
a pump device;
a hydraulic circuit connecting the aspiration needle to the reading cell container to enable their filling by the sample, guaranteed by an optical sensor comprising the collimated light source and an optical receiver, and a secondary optical flow sensor controlled by the electronic control device.

4. The apparatus of claim 3 wherein the reading cell container is equipped with electromechanical actuators to vibrate the sample therein.

5. The apparatus of claim 5 wherein the reading cell container includes a temperature control system linked to the electronic control device reaction environment standardization.

6. The apparatus of claim 5 wherein the electronic control device is configured to convert a detected time dependent light variation into an aggregation index and a subsequent erythrocyte sedimentation rate, providing a result of an evaluated phenomenon as a numerical result.

7. The apparatus of claim 1 wherein the collimated light source includes a light emitting diode (LED).

8. The apparatus of claim 7 wherein the optical detector includes a charge-coupled device (CCD) sensor.

9. The apparatus of claim 7 wherein the optical detector includes a linear photodiode array.

10. The apparatus of claim 1 further comprising a waste reservoir for containing an evacuated sample from the reading cell container.

11. An apparatus for determining the aggregation rate of red blood cells, and aggregant plasma proteins index, the apparatus comprising:
an optical receiver positioned to detect light from a blood sample portion comprising red blood cells that have aggregated;
a main controller coupled to the optical receiver for recording an aggregation rate of the red blood cells of the blood sample portion upon detected light variation;
a hydraulic circuit for providing the blood sample portion; and
a light emitter source to pass light into the blood sample portion.

12. The apparatus of claim 11, further comprising:
a reading cell container connected to the hydraulic circuit for receiving the blood sample portion.

13. The apparatus of claim 11, wherein the aggregation rate of the blood cells of the blood sample portion is recorded for a predetermined time based upon detected light variation.

14. The apparatus of claim 12, further comprising:
a disruption mechanism connected to the reading cell container for disruption of the red blood cells within the blood sample portion to assist in recording the disruption rate,
wherein the main controller activates the disruption mechanism for the disruption of the red blood cell within the blood sample portion until light detected indicates the disruption of aggregate within the blood sample portion.

15. The apparatus of claim 12, further comprising:
a fluid reservoir connected to the reading cell container for receipt of an evacuated blood sample portion from the reading cell container.

16. The apparatus of claim 12, wherein the apparatus comprises an evacuation mechanism to evacuate the evacuated blood sample portion from the reading cell container,
wherein the evacuation mechanism is configured to provide ultrasound stress to the reading cell container.

17. The apparatus of claim 12, wherein the reading cell container is configured for the optical detection of aggregation reaction.

18. The apparatus of claim 14, wherein the apparatus determines a disruption index of the red blood cells as rheological parameters usable for pathologic detection purposes.

19. The apparatus of claim 11, wherein the apparatus determines a mean red blood cells shape recovery ability.
